(19) United States
(12) Patent Application Publication
(10) Pub. No.: US 2026/0322131 A1
(43) Pub. Date: Oct. 15, 2026

(54) POWER CONVERSION APPARATUS AND METHOD OF CONTROLLING THE SAME

(71) Applicant: HANWHA SOLUTIONS CORPORATION, Seoul (KR)

(72) Inventors: Jong Won SONG, Seoul (KR); Yeong Jin KIM, Seoul (KR); Il Kyu PARK, Seoul (KR); Seong Hoon HA, Seoul (KR); Seong Hun LEE, Seoul (KR)

(73) Assignee: HANWHA SOLUTIONS CORPORATION, Seoul (KR)

(21) Appl. No.: 19/630,763

(22) Filed: Mar. 27, 2026

(30) Foreign Application Priority Data
Apr. 9, 2025 (KR) 10-2025-0045937

(51) Int. Cl. H02J 3/38; H02J 101/24; H02M 1/00; H02M 7/5395

(52) U.S. Cl. CPC H02J 3/38; H02M 1/0032; H02M 1/0054; H02M 7/5395; H02J 2101/25

(57) ABSTRACT

A power conversion apparatus and a method of controlling the same are provided. The method of controlling a power conversion apparatus includes determining an operation mode of a power conversion apparatus, and, based on the operation mode being determined as a low-power mode, controlling the power conversion apparatus such that an output current exhibits a discontinuous waveform including an operation interval and a pause interval, wherein each of the length of the operation interval and the length of the pause interval is set to be shorter than an alternating current voltage period of a power grid to which the power conversion apparatus is connected.

### CROSS-REFERENCE TO RELATED APPLICATION

This application is based on and claims priority under 35 USC § 119 to Korean Patent Application No. 10-2025-0045937, filed on Apr. 9, 2025, in the Korean Intellectual Property Office, the disclosure of which is incorporated by reference herein in its entirety.

### BACKGROUND

### 1. Field

The present disclosure relates to a power conversion apparatus and a method of controlling the same.

### 2. Description of the Related Art

Recently, as the distribution of power supply systems using photovoltaic power generation has expanded, efficient and stable power conversion technologies have been developing. In particular, grid-connected power conversion apparatuses must stably handle highly variable outputs in environments where solar irradiance changes, and optimized control is required for this purpose.

However, according to the related art, power conversion efficiency may be degraded in low-output ranges, and a method of completely pausing some periods of the output current to reduce switching loss may cause the current waveform to be interrupted and reactive power control to be limited.

Accordingly, there is a need to develop a power conversion apparatus capable of flexible phase control that can continuously maintain a current waveform while minimizing switching loss through efficient switching operation under various output conditions.

The background technology described above is technical information that the inventor possessed for the purpose of deriving the present disclosure or acquired in the process of deriving the present disclosure, and may not necessarily be considered as publicly known technology disclosed to the general public prior to the application for the present disclosure.

### SUMMARY

The present disclosure provides a power conversion apparatus and a method of controlling the same. The objectives to be solved by the present disclosure are not limited to the problems described above, and other problems and advantages of the present disclosure that are not described may be understood through the following description and will be more clearly understood through embodiments of the present disclosure. In addition, it will be appreciated that the problems and advantages to be solved by the present disclosure may be realized by the means and combinations thereof indicated in the patent claims.

As a technical means for achieving the above-described technical task, a first aspect of the present disclosure may provide a method of controlling a power conversion apparatus, the method including determining an operation mode of a power conversion apparatus, and, based on the operation mode being determined as a low-power mode, controlling the power conversion apparatus such that an output current exhibits a discontinuous waveform including an operation interval and a pause interval, wherein each of the length of the operation interval and the length of the pause interval is set to be shorter than an alternating current voltage period of a power grid to which the power conversion apparatus is connected.

A second aspect of the present disclosure provides a power conversion apparatus including a controller configured to control the operation of the power conversion apparatus, wherein the controller is further configured to determine an operation mode of the power conversion apparatus, and, based on the operation mode being determined as a low-power mode, control the power conversion apparatus such that an output current exhibits a discontinuous waveform including an operation interval and a pause interval, and each of the lengths of the operation interval and the pause interval is set to be shorter than an alternating current voltage period of a power grid to which the power conversion apparatus is connected.

Other aspects, features and advantages other than those described above will become apparent from the following drawings, patent claims and detailed description of the disclosure.

### BRIEF DESCRIPTION OF THE DRAWINGS

The following drawings attached to this specification are intended to illustrate at least an embodiment according to the present disclosure, and together with the detailed description of the disclosure described below, serve to further understand the technical idea of the present disclosure, and therefore, the present disclosure should not be interpreted as being limited to matters described in the drawings in which:

FIG. 1 shows a view to schematically explain a power supply system;

FIG. 2 shows an example of a power supply system according to an embodiment;

FIG. 3 shows an example of a power supply system according to another embodiment;

FIG. 4 shows an example of a power supply system according to another embodiment;

FIG. 5 shows a view to explain a power conversion apparatus according to an embodiment;

FIG. 6 shows an example of a method of controlling a power conversion apparatus;

FIG. 7 shows a view to explain continuous waveforms and discontinuous waveforms;

FIG. 8 shows a view to explain an operation interval and a pause interval;

FIG. 9 shows a view to explain a process of controlling a power conversion apparatus based on pulse width modulation (PWM) switching;

FIGS. 10 and 11 show views to explain an operation interval or a pause interval, of which lengths change over time; and

FIG. 12 shows a view to explain a reactive power control process.

### DETAILED DESCRIPTION

The advantages and features of the present disclosure and the methods for achieving them will become apparent with reference to the embodiments described in detail together with the accompanying drawings. However, the present disclosure is not limited to the embodiments presented below, but may be implemented in various different forms, and should be understood to include all transformations, equivalents, or substitutes included in the spirit and technical scope of the present disclosure. The embodiments presented below are provided to make this disclosure complete and to fully inform those skilled in the art of the scope of the disclosure. In explaining the present disclosure, if it is determined that a detailed description of a related known technology may obscure the gist of the present disclosure, the detailed description is omitted.

The terminology used herein is for the purpose of describing particular embodiments only and is not intended to limit the present disclosure. Unless otherwise defined, all terms used herein have the same meaning as commonly understood by one of ordinary skill in the art to which this disclosure belongs.

In this specification, singular expressions include plural expressions unless the context clearly indicates otherwise. Additionally, it should be understood that terms such as “include” or “have” are intended to specify the presence of a feature, number, step, operation, component, part or combination thereof described in the specification, but do not preclude the possibility of the presence or addition of one or more other features, numbers, steps, operations, components, parts or combinations thereof.

Additionally, terms including ordinal numbers, such as “first” or “second,” used herein may be used to describe various components, but the components should not be limited by the terms. Terms are used solely to distinguish one component from another.

The appearances of phrases such as “in an embodiment,” “according to an embodiment,” “relating to an embodiment,” or “according to an implementation of an embodiment” in this specification do not necessarily all refer to the same embodiment. Additionally, throughout the specification, the term “embodiment” is an arbitrary distinction used to facilitate the description of the present disclosure, and each embodiment need not be mutually exclusive. For example, configurations described for the purpose of describing an embodiment may be applied and/or implemented in other embodiments, and may be applied and/or implemented with modifications without departing from the scope of the present disclosure.

Some embodiments of the present disclosure may be represented by functional block configurations and various processing steps. Some or all of these functional blocks may be implemented with any number of hardware and/or software configurations that perform specific functions. For example, the functional blocks of the present disclosure may be implemented by one or more microprocessors or by circuit configurations for a given function.

For example, the functional blocks of the present disclosure may be implemented in various programming or scripting languages. Functional blocks may be implemented as algorithms that run on one or more processors. Additionally, the present disclosure may employ conventional techniques for electronic environment setting, signal processing, and/or data processing. Terms such as “mechanism,” “element,” “means,” and “configuration” may be used broadly and are not limited to mechanical and physical configurations. Additionally, terms such as “-unit,” “-module,” etc. refer to a unit that processes at least one function or operation, which may be implemented as hardware or software, or a combination of hardware and software.

Additionally, the connecting lines or connecting members between components depicted in the drawings are merely exemplary representations of functional connections and/or physical or circuit connections. In an actual device, connections between components may be represented by various functional, physical, or circuit connections that may be replaced or added.

Additionally, some components in the drawing may be depicted with somewhat exaggerated sizes or proportions. Additionally, components depicted in one drawing may not be depicted in another drawing.

Hereinafter, embodiments of the present disclosure will be described in detail with reference to the attached drawings.

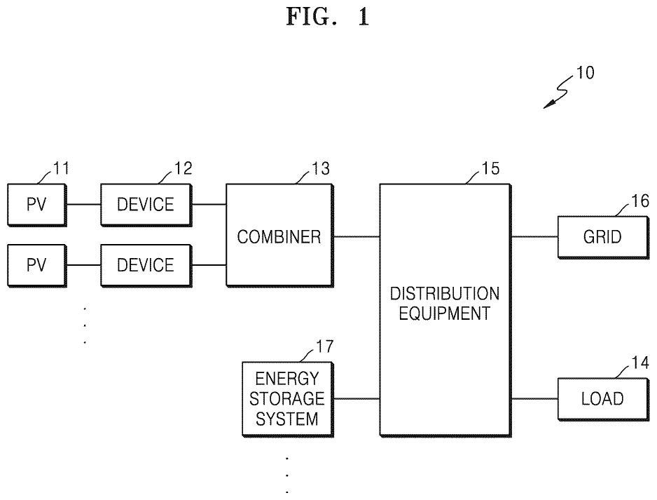

FIG. 1 shows a view to schematically explain a power supply system.

Referring to FIG. 1, a power supply system 10 may include a photovoltaic module 11, a device 12, a load 14, and/or distribution equipment 15. The power supply system 10 may be connected to the power grid 16 outside.

At least one photovoltaic module 11 may be installed on the roof or exterior wall of a building to generate electricity. The photovoltaic module 11 may be connected in multiples to form a photovoltaic module array.

The photovoltaic module 11 may be connected to the device 12. For example, at least one device 12 may be connected to each photovoltaic module 11. In some embodiments, in case that one device 12 is connected to each photovoltaic module 11, the number of devices 12 constituting the power supply system 10 may be the same as the number of photovoltaic modules 11.

The device 12 may be a power conditioning system or a power conversion system (PCS) that performs power conversion on power generated by the photovoltaic module 11. For example, the device 12 may perform a certain conversion on the power generated from the photovoltaic module 11 and supply the converted power to other components of the power supply system 10 (e.g., power grid 16 and/or load 14, etc.).

In some embodiments, the device 12 may be module level power electronics (MLPE). For example, the device 12 may be an optimizer or a micro inverter (MI).

In some embodiments, in case that the device 12 is an optimizer, the device 12 may regulate the power produced from the photovoltaic module 11 and output the same to an inverter (e.g., a string inverter). The current converted by the inverter (e.g., converting direct current into alternating current) may be output to the power grid 16 or the load 14. Meanwhile, in case that the device 12 is an optimizer, the power supply system 10 may further include a separate inverter (e.g., a string inverter, etc.) that converts the direct current output from the device 12 into alternating current.

In some embodiments, in case that the device 12 is a microinverter, the device 12 may convert power generated from the photovoltaic module 11 (e.g., converting direct current into alternating current). The current converted in the device 12 may be output to a power grid 16 or the load 14.

If necessary, the power supply system 10 may further include a combiner 13. At least a portion of the device 12 may be connected to the distribution equipment 15 via the combiner 13. For example, power output from multiple devices 12 may be combined into one output by the combiner 13 and supplied to the distribution equipment 15.

Meanwhile, the device 12 and the distribution equipment 15 may be connected by a power path that does not include the combiner 13, and at least one device 12 may be connected to the distribution equipment 15 by a power path that does not include the combiner 13, and at least one other device 12 may be connected to the distribution equipment 15 via the combiner 13.

The combiner 13 may control the voltage, current and/or power output from the device 12 according to the power supply status of the photovoltaic module 11, the device 12 and/or the power grid 16, and the operation mode of the combiner 13 may be set to a diagnostic mode or an operation mode, etc.

In some embodiments, the combiner 13 may include an energy management system (EMS) that controls an operation of the combiner 13. The EMS may control the voltage, current and/or power supplied to or output from the combiner 13 according to the power supply status of the photovoltaic module 11, device 12 and/or power grid 16, and may set the operation mode of the combiner 13 to a diagnostic mode or an operation mode, etc.

The load 14 refers to an object that is installed in an electric power consumer such as a house, commercial facility, or factory and operates by receiving at least one of energy generated by the photovoltaic module 11, energy stored in an energy storage system 17, and/or energy supplied from the power grid 16. For example, in case that the electricity consumer receiving the power is a house, the load 14 may include home appliances such as a washing machine, a refrigerator, or TV.

The power grid 16 may include an infrastructure system for generating, transmitting, and distributing power. For example, the power grid 16 may include infrastructure systems such as power plants, substations, and power lines. Meanwhile, the power grid 16 may transmit electric energy generated at the power plant to the power supply system 10 or transmit surplus power generated in the power supply system 10 to the outside of the power supply system 10.

For example, commercial power transmitted from the power grid 16 through a power pole may be supplied to a power consumer through a transformer. Meanwhile, the power supply system 10 may be implemented as an off-grid system that is not connected to the power grid 16.

Meanwhile, the power supply system 10 may further include at least one energy storage system 17. If necessary, the power supply system 10 may include a plurality of energy storage systems 17. The energy storage system 17 may receive and store power generated by the photovoltaic module 11 and/or power transmitted from the power grid 16. The energy storage system 17 may efficiently supply power by storing power and supplying power to the load 14 when the load 14 needs the power.

The energy storage system 17 may include a battery that stores power and a power conversion module. The battery may be equipped with a battery management system (BMS) that monitors a state of charge (SOC), a state of health (SOH), voltage, and/or current of the battery, performs diagnostics on the battery, and performs safety functions such as current cutoff.

In some embodiments, the power conversion module may be a PCS that performs conversion between power on the battery side and power on the opposite side. For example, the PCS may convert between direct current on the battery side and alternating current on the opposite side. In some embodiments, the PCS may include a bidirectional direct current (DC)-DC converter that is connected to the battery to convert voltage, and a bidirectional inverter connecting the DC-DC converter to an exterior of the energy storage system 17.

In some embodiments, the energy storage system 17 may further include an EMS that controls the operation of the energy storage system 17. The EMS may control the voltage, current and/or power supplied to or output from the energy storage system 17 according to the power supply status of the battery and/or power grid 16, and may set the operation mode of the energy storage system 17 to a diagnostic mode or an operation mode, etc.

As needed, an EMS coupled to a given component of the power supply system 10 may control not only the operation of the given component, but also further control the operation of other components of the power supply system 10. For example, an EMS coupled to the combiner 13 or an EMS coupled to an energy storage system 17 may control both the operation of the combiner 13 and the operation of the energy storage system 17.

In some embodiments, the distribution equipment 15 provides electrical connection between components of the power supply system 10 and may control the power flow of the power supply system 10. For example, the distribution equipment 15 may electrically connect the photovoltaic module 11 to the load 14. In some embodiments, the distribution equipment 15 may be connected to the device 12 connected to the photovoltaic module 11 to electrically connect the photovoltaic module 11 to the load 14. If necessary, the distribution equipment 15 may be further connected to at least one of the energy storage system 17 and the power grid 16.

For example, the distribution equipment 15 may be a distribution panel that distributes power within the power supply system 10. In some embodiments, the distribution equipment 15 may be a master service panel (MSP) that distributes power generated by the photovoltaic module 11 to the load 14 and the like.

In some embodiments, the distribution equipment 15 may be a master controller that performs power distribution within a power supply system and controls each device 12. In some embodiments, the master controller may include a switch, a circuit breaker, and a control unit. The switch, the circuit breaker, and the control unit may each be implemented as independent devices, or at least some of the switch, the circuit breaker, and the control unit may be included in a single device.

The master controller may include a switch that controls the electrical connection between components connected to the master controller, such as the device 12 and the load 14. For example, the master controller may include a relay or power semiconductor that provides or blocks electrical connection to the device 12 and/or the energy storage system 17 depending on the operating status of each component of the power supply system 10.

The master controller may perform a rapid shutdown to stop the power generation of the photovoltaic module 11 in an emergency situation such as an overcurrent occurrence in the power supply system 10. For this purpose, the master controller may include a circuit breaker that blocks the connection between the device 12 and the load 14.

The master controller may include a control unit that controls the overall operation of the master controller. The control unit may control operations of other components of the power supply system 10 (for example, the device 12 or the energy storage system 17, etc.) in addition to the master controller.

The control unit may perform control on the voltage, current and/or power output from or supplied to each component according to the power supply status of the photovoltaic module 11, the device 12, the combiner 13, the load 14, the power grid 16, and/or the energy storage system 17. In some embodiments, the control unit may set the operation mode of the master controller, the device 12 and/or the energy storage system 17 to a diagnostic mode or an operation mode, etc.

For example, the control unit may control the photovoltaic module 11, the device 12, the combiner 13, and/or the energy storage system 17 based on the status of the power supply system 10. In some embodiments, the control unit may control other components of the power supply system 10 by causing the master controller to communicate with other components (e.g., the device 12) of the power supply system 10. Communication between the master controller and other components of the power supply system 10 may be performed using power line communication (PLC), but is not limited thereto.

In some embodiments, the control unit may control the device 12 according to the power generation status of the photovoltaic module 11. For example, the master controller may receive a control command from a server that monitors the power generation status of the photovoltaic module 11, and the control unit may control the device 12 according to the control command.

The master controller may supply power to at least a portion of the load 14 when the power supply from the power grid 16 is not smooth (e.g., in an off-grid situation). For example, when the power supply from the power grid 16 is not smooth, the master controller may preferentially supply the power generated from the photovoltaic module 11 and/or the power stored in the energy storage system 17 to a backup load that has a relatively high need for stable power supply.

Meanwhile, the power supply system 10 may further include an auxiliary power generation device (e.g., a diesel generator, etc.) that generates power in a separate manner other than photovoltaic power generation. For example, an auxiliary power generation device may be further connected to the distribution equipment 15. In cases where the master controller may not respond to the backup load with only the photovoltaic module 11 and the energy storage system 17 due to environmental factors such as time of day or weather, the master controller may supply power generated by the auxiliary power generation device to the backup load.

The control unit may be implemented by at least one processor. A processor may process instructions in a computer program by performing basic arithmetic, logic, and input/output operations. In this regard, the instructions may be provided from an internal memory of the master controller or from an external device. In some embodiments, the processor may control the overall operation of other components included in the master controller.

Meanwhile, the processor may perform at least some of the data analysis, processing, and result information generation for performing the operations described above by using at least one of a machine learning, neural network, or deep learning algorithm as a rule-based or artificial intelligence algorithm. Examples of neural networks include neural network models based on architectures such as a convolutional neural network (CNN), a deep neural network (DNN), and a recurrent neural network (RNN).

For example, a processor may be implemented as an array of a number of logic gates, or may be implemented as a combination of a general-purpose microprocessor and a memory storing a program that may be executed on the microprocessor. For example, a processor may include a general purpose processor, a central processing unit (CPU), a microprocessor, a digital signal processor (DSP), a controller, a microcontroller, a state machine, etc.

In some environments, the processor may include an application specific integrated circuit (ASIC), a programmable logic device (PLD), a field programmable gate array (FPGA), and the like. For example, a processor may refer to a combination of processing devices, such as a combination of a digital signal processor (DSP) and a microprocessor, a combination of a plurality of microprocessors, a combination of one or more microprocessors combined with a DSP core, or a combination of any other such configurations.

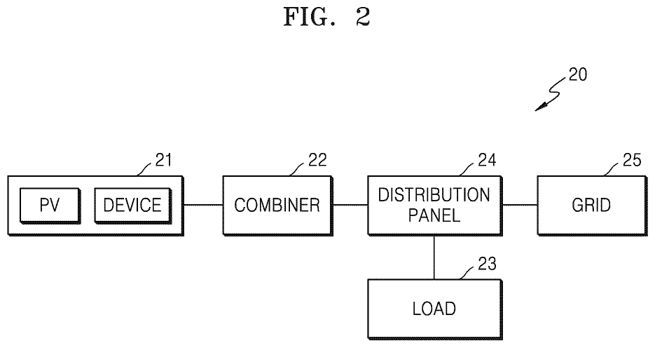

By combining at least some of the components as described above, the power supply system 10 may be implemented in various forms. Hereinafter, various embodiments of the power supply system 10 will be described with reference to FIGS. 2 to 4. However, the implementation method of the power supply system 10 is not limited to the embodiment described below.

FIG. 2 shows an example of a power supply system according to an embodiment.

Referring to FIG. 2, a power supply system 20 according to an embodiment may include a photovoltaic power generation device 21, a combiner 22, a load 23, and a distribution panel 24. In some embodiments, the power supply system 20 may be connected to a power grid 25 outside. In some embodiments, the combiner 22, the load 23, and the power grid 25 illustrated in FIG. 2 may correspond to the combiner 13, the load 14, or the power grid 16 illustrated in FIG. 1, respectively. In some embodiments, the distribution panel 24 illustrated in FIG. 2 may be the same as the distribution panel described above with reference to FIG. 1.

A photovoltaic power generation device 21 may include the photovoltaic module 11 and the device 12 illustrated in FIG. 1. For example, the photovoltaic power generation device 21 may include a photovoltaic module equipped with a micro inverter or a photovoltaic module equipped with an optimizer. In case that the device does not convert direct current to alternating current, the photovoltaic power generation device 21 may further include a separate inverter that converts direct current to alternating current.

The combiner 22 may electrically connect the photovoltaic power generation device 21 and the distribution panel 24. A plurality of photovoltaic power generation devices 21 may be connected to one combiner 22. For example, the combiner 22 may combine power output from multiple photovoltaic power generation devices 21 into one output and supply the same to the distribution panel 24.

Through this, the power supply system 20 may supply power generated from the photovoltaic power generation device 21 to the load 23 and/or the power grid 25 through the distribution panel 24.

Meanwhile, the combiner 22 may control the voltage, current and/or power output from the photovoltaic power generation device 21 according to the power supply status of the photovoltaic power generation device 21, the load 23 and/or the power grid 25, and the operation mode of the combiner 22 may be set to a diagnostic mode or an operation mode, etc.

Meanwhile, at least one photovoltaic power generation device 21 and the distribution panel 24 may be connected to a power path that does not include the combiner 22. For example, at least one photovoltaic power generation device 21 may be connected to the distribution panel 24 via a power path that does not include the combiner 22, and at least another photovoltaic power generation device 21 may be connected to the distribution panel 24 via the combiner 22.

In an embodiment, the power supply system 20 may further include a sub-panel not shown connected to the distribution panel 24. In this regard, at least one photovoltaic power generation device 21 may be connected to a sub-panel through the combiner 22, and at least another photovoltaic power generation device 21 may be directly connected to the sub-panel.

The power supply system 20 may increase the total power generation amount of the photovoltaic power generation device 21 that may be integrated into the power supply system 20 by having a sub-panel that provides additional capacity.

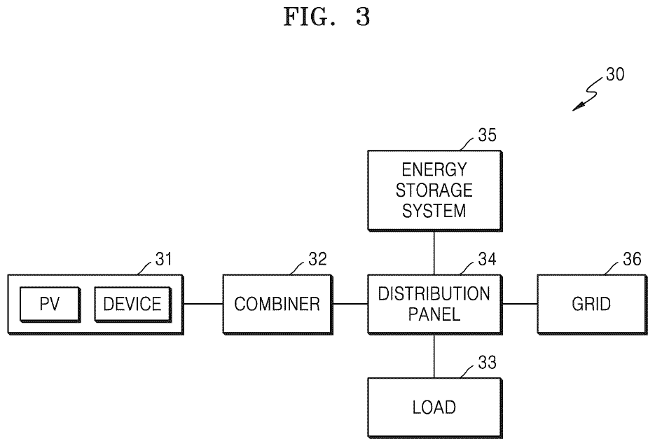

FIG. 3 shows an example of a power supply system according to another embodiment.

Referring to FIG. 3, a power supply system 30 according to an embodiment may include a photovoltaic power generation device 31, a combiner 32, a load 33, a distribution panel 34, and an energy storage system 35. In some embodiments, the power supply system 30 may be connected to a power grid 36 outside.

The power supply system 30 illustrated in FIG. 3 may be further equipped with at least one energy storage system 35 in addition to the power supply system 20 illustrated in FIG. 2. In an embodiment, the energy storage system 35 is connected to the distribution panel 34 and may be charged or discharged. In another embodiment, the energy storage system 35 may be connected to the combiner 32 and may be charged or discharged.

By further providing the energy storage system 35 to the power supply system 30, in case that the load 33 may not be handled by the photovoltaic power generation device 31 alone, the power stored in the energy storage system 35 may be used to handle the load 33. In some embodiments, in case that the power generated by the photovoltaic power generation device 31 exceeds the amount of power required to respond to the load 33, the excess may be stored in the energy storage system 35. Meanwhile, in case that the charge amount of the energy storage system 35 is not more than a critical level and the power generated by the photovoltaic power generation device 31 does not exceed the amount of power required to respond to the load 33, the energy storage system 35 may be charged with power supplied from the power grid 36.

Through this, the power supply system 30 may perform efficient power supply to the load 33 using the energy storage system 35.

Meanwhile, the combiner 32 may control the voltage, current and/or power output from the photovoltaic power generation device 31 according to the power supply status of the photovoltaic power generation device 31, the load 33 and/or the power grid 36, and the operation mode of the combiner 32 may be set to a diagnostic mode or an operation mode, etc.

In addition, the energy storage system 35 may control the voltage, current and/or power supplied to or output from the energy storage system 35 according to the power supply status of the photovoltaic power generation device 31, the load 33 and/or the power grid 36, and the operation mode of the energy storage system 35 may be set to a diagnostic mode or an operation mode, etc.

In an embodiment, the power supply system 30 may further include a sub-panel not shown connected to the distribution panel 34. In this regard, at least one photovoltaic power generation device 31 may be connected to a sub-panel through the combiner 32, and at least one other photovoltaic power generation device 31 may be directly connected to the sub-panel.

In some embodiments, at least one energy storage system 35 may be connected to the combiner 32, the distribution panel 34, or the sub-panel and integrated into the power supply system 30.

Meanwhile, at least one photovoltaic power generation device 31 and the distribution panel 34 may be connected to a power path that does not include the combiner 32. For example, at least one photovoltaic power generation device 31 may be connected to the distribution panel 34 via a power path that does not include the combiner 32, and at least another photovoltaic power generation device 31 may be connected to the distribution panel 34 via the combiner 32.

In an embodiment, at least one photovoltaic power generation device 31 may be connected to the sub-panel via the combiner 32, and at least one other photovoltaic power generation device 31 may be connected directly to the sub-panel.

The power supply system 30 may increase the total power generation amount of the photovoltaic power generation device 31 that may be integrated into the power supply system 30 by having a sub-panel that provides additional capacity.

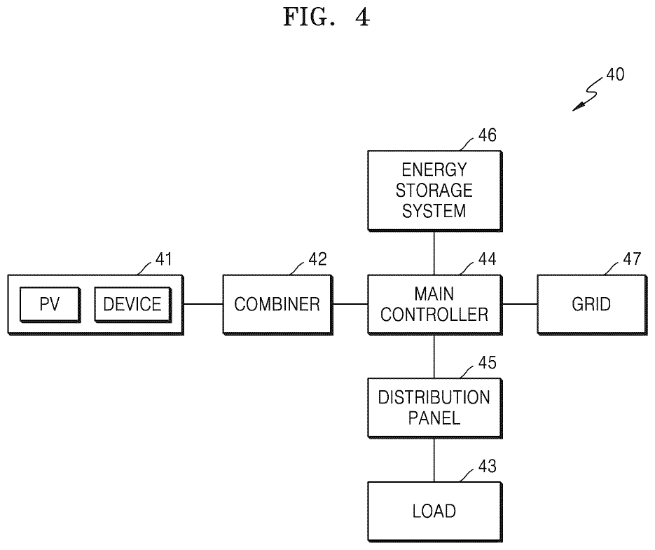

FIG. 4 shows an example of a power supply system according to another embodiment.

Referring to FIG. 4, a power supply system 40 according to an embodiment may include a photovoltaic power generation device 41, a combiner 42, a load 43, a master controller 44, a distribution panel 45, and an energy storage system 46. In some embodiments, the power supply system 40 may be connected to a power grid 47 outside.

Meanwhile, the photovoltaic power generation device 41, the combiner 42, the load 43, and the energy storage system 46 illustrated in FIG. 4 may correspond to the photovoltaic power generation device 31, the combiner 32, the load 33, or the energy storage system 35 illustrated in FIG. 3, respectively. In some embodiments, the master controller 44 illustrated in FIG. 4 may correspond to the master controller described above with reference to FIG. 1.

The combiner 42 may electrically connect at least one photovoltaic power generation device 41 to the master controller 44. For example, the combiner 42 may combine power output from at least one photovoltaic power generation device 41 into one output and supply the same to the master controller 44.

The master controller 44 may electrically connect the combiner 42, the distribution panel 45, and the power grid 47 to each other. In some embodiments, the master controller 44 may connect the components described above and auxiliary power sources such as the energy storage system 46 and/or an auxiliary power generation device (e.g., a diesel generator, etc.). For example, the master controller 44 may output power supplied from the combiner 42 to the distribution panel 45, the energy storage system 46, and/or the power grid 47. In some embodiments, the master controller 44 may output power supplied from the power grid 47 to the distribution panel 45 or the energy storage system 46. In some embodiments, the master controller 44 may output power supplied from the energy storage system 46 to the distribution panel 45.

The distribution panel 45 may electrically connect the master controller 44 and at least one load 43 to each other. Through this, the power supply system 40 may supply power generated from the photovoltaic power generation device 41 to the load 43 through the distribution panel 45.

The power supply system 40 may integrate multiple energy storage systems 46 and/or auxiliary power generation devices into the power supply system 40 by having the master controller 44, thereby supplying power stably. In some embodiments, the power supply system 40 may stably supply power to the load 43 such as a backup load even in an off-grid environment where power may not be stably supplied from the power grid 47.

Meanwhile, the master controller 44 may control the voltage, current and/or power output from or supplied to each component according to the status of the photovoltaic power generation device 41, the load 43, the energy storage system 46, and/or the power grid 47, and may set the operation mode of the master controller 44, the photovoltaic power generation device 41, and/or the energy storage system 46 to a diagnostic mode or an operation mode, etc.

In an embodiment, the power supply system 40 may further include a sub-panel (not shown) connected to the master controller 44 and distinct from the distribution panel 45. In this regard, at least one backup load having a relatively high need for stable power supply among the loads 43 may be connected to the sub panel, and at least one non-backup load having a relatively low need for stable power supply among the loads 43 may be connected to the distribution panel 45.

The master controller 44 may electrically connect the combiner 42, the distribution panel 45, the energy storage system 46, the power grid 47, and the sub-panel to each other. The master controller 44 may supply power supplied from the combiner 42, the energy storage system 46 and/or the power grid 47 to at least one non-backup load through the distribution panel 45 and to the backup load through the sub-panel.

In an embodiment, the power supply system 40 may further include a sub-panel connected to the master controller 44 and distinct from the distribution panel 45, and the power grid 47 may be connected to the distribution panel 45 instead of being connected to the master controller 44. That is, the master controller 44 may electrically connect the combiner 42, the distribution panel 45, the energy storage system 46, and the sub-panel to each other, and the distribution panel 45 may electrically connect the master controller 44, the non-backup load, and the power grid 47 to each other.

For example, the power supply system 40 may be implemented by connecting the master controller 44 that connects the combiner 42 and the energy storage system 46 to the distribution panel 45 that is pre-installed to connect at least one load 43 and the power grid 47.

Through this, the power supply system 40 may stably supply power to the load 43 such as a backup load even in an off-grid environment where power may not be stably supplied from the power grid 47.

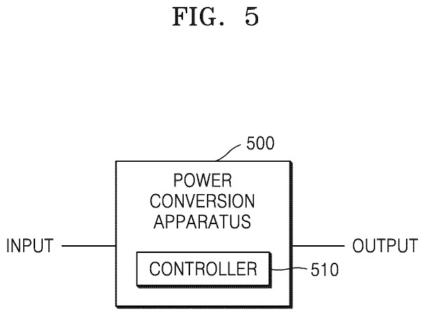

FIG. 5 shows a view to explain a power conversion apparatus according to an embodiment.

Referring to FIG. 5, a power supply system according to an embodiment may include the power conversion apparatus 500. In this regard, the power supply system may include the power supply system 10 described above with reference to FIG. 1, etc.

The power conversion apparatus 500 may include any type of conversion device that performs conversion between direct current and alternating current, or conversion of at least one of voltage, current, and frequency. In an embodiment, the power conversion apparatus 500 may include a bidirectional conversion device that has one side connected to a battery system or the like and may convert voltage and current in different directions. Additionally, in an embodiment, the power conversion apparatus 500 may include, but is not limited to, a device that converts a direct current voltage on the input side into an alternating current voltage on the output side.

In an embodiment, the power conversion apparatus 500 may include a grid-connected power conversion apparatus having an input to which a direct current power source is connected and an output to which a power grid is connected. For example, the power conversion apparatus 500 may include the device 12 described above with reference to FIG. 1, etc.

In some embodiments, at least one photovoltaic module 11 that converts light energy into electrical energy to generate power in the form of direct current may be connected to the input of the power conversion apparatus 500. In some embodiments, the output of the power conversion apparatus 500 may be directly connected to the power grid 16 or may be connected thereto through at least one other component (e.g., the combiner 13 and/or the distribution equipment 15).

In some embodiments, the power supply system may include another direct current power source (e.g., another type of power generation system based on a fuel cell, etc.) distinct from the photovoltaic module 11, and the direct current power source may be connected to the input of the power conversion apparatus 500, and the power grid 16 may be connected to the output of the power conversion apparatus 500.

Referring again to FIG. 5, the power conversion apparatus 500 may include a controller 510. In this regard, the controller 510 may control the overall operation of the power conversion apparatus 500. The controller 510 according to an embodiment may include at least one processor.

The processor may include at least one of application specific integrated circuits (ASICs), a digital signal processor (DSP), a digital signal processing device (DSPD), a programmable logic device (PLD), a field programmable gate array (FPGA), a micro-controller, a microprocessor, and/or various electrical units for performing other processing functions.

The controller 510 according to an embodiment may further include a memory. In this regard, the memory may be hardware that stores programs for various operations, processing, and control of the controller 510, and may also store various data processed within the controller 510. In an embodiment, the memory may store various data for the processor to perform operations by executing a program. According to an embodiment, a processor may control the operation of a controller 510 by executing a program stored in memory.

The memory may include random access memory (RAM) such as dynamic random access memory (DRAM) and static random access memory (SRAM), read-only memory (ROM), electrically erasable programmable read-only memory (EEPROM), CD-ROM, Blu-ray or other optical disk storage, hard disk drive (HDD), solid state drive (SSD), or flash memory.

Meanwhile, the controller 510 may not constitute the power conversion apparatus 500, unlike as shown in FIG. 5, and may include other hardware distinct from the power conversion apparatus 500. For example, the controller 510 may include at least one processor that constitutes other components (e.g., the combiner 13, etc.) illustrated in FIG. 1. In this regard, a control signal for controlling the power conversion apparatus 500 may be generated outside the power conversion apparatus 500 and input to the power conversion apparatus 500.

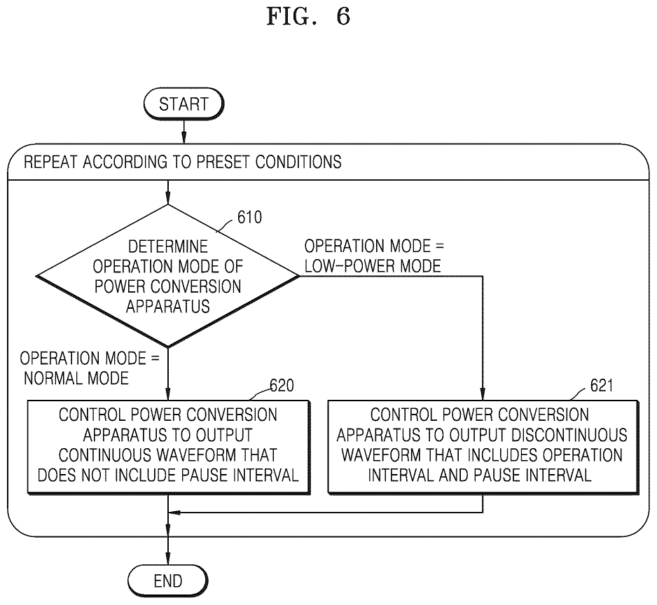

Hereinafter, various examples of a method for the controller 510 to control the power conversion apparatus 500 will be described with reference to FIG. 5 and FIG. 6, etc.

FIG. 6 shows an example of a method of controlling a power conversion apparatus

Referring to FIG. 6, in operation 610, the controller 510 may determine the operation mode of the power conversion apparatus 500. In an embodiment, the controller 510 may determine the operation mode of the power conversion apparatus 500 as any one of a plurality of preset operation modes. In this regard, the operation mode may indicate how the power conversion apparatus 500 will perform power conversion.

In an embodiment, the plurality of operation modes preset for the power conversion apparatus 500 may include a normal mode and a low-power mode. In the present disclosure, the normal mode is an operation mode in which the power conversion apparatus 500 provides an output power close to the rated power, and the low-power mode is an operation mode in which the power conversion apparatus 500 provides a relatively low output power.

Meanwhile, in an embodiment, the plurality of operation modes set for the power conversion apparatus 500 may further include other operation modes in addition to the normal mode and the low-power mode, and the low-power mode and/or the normal mode may include subdivided operation modes.

In an embodiment, the controller 510 may determine the operation mode based on the output power level of the power conversion apparatus 500. For example, the controller 510 may determine whether the output power level of the power conversion apparatus 500 corresponding to the current point in time exceeds a preset threshold value (e.g., a value corresponding to 30% of the maximum output or rated output, etc.). Thereafter, the controller 510 may determine the operation mode of the power conversion apparatus 500 as the normal mode based on whether the output power level exceeds the preset threshold value, and may determine the operation mode of the power conversion apparatus 500 as the low-power mode based on whether the output power level does not exceed the preset threshold value.

The threshold for determining the operation mode may be designed by considering the maximum output, rated output, environmental factors of the power supply system, and target efficiency of the power conversion apparatus 500, and two or more step-by-step thresholds (e.g., 20% and 30% of the maximum output, etc.) may be set to plan a detailed multiple low-power mode.

Meanwhile, the output power level of the power conversion apparatus 500 may indicate the size of the power being output, but may also indicate a control target value determined to be output in response to the power currently being supplied. That is, the output power level may be determined by the controller 510, and the controller 510 may determine the output power level of the power conversion apparatus 500 by reflecting the current state of the power supply system.

As described above with reference to FIG. 5, etc., the power conversion apparatus 500 according to an embodiment may include a grid-connected power conversion apparatus which has an input to which a photovoltaic module is connected and an output to which a power grid is connected. In an embodiment, the controller 510, or a maximum power point tracking (MPPT) module configured separately from the controller 510, may use an MPPT algorithm to search for a maximum power point at which maximum power can be extracted from the photovoltaic module.

The output power level of the power conversion apparatus 500 according to an embodiment may be a power level corresponding to an operating point determined based on an MPPT algorithm. In an embodiment, the inputs of the MPPT algorithm may include input voltage, input current, and current temperature of the power conversion apparatus 500. Additionally, the operating point determined based on the MPPT algorithm may represent the maximum power point derived as the output of the MPPT algorithm.

In operation 620, the controller 510 may control the power conversion apparatus 500 such that the output current exhibits a continuous waveform based on the operation mode being determined as the normal mode. In this case, a continuous waveform refers to a waveform that does not include a pause interval. In the present disclosure, a pause interval refers to a time period during which the output current remains substantially at 0. Meanwhile, the pause interval is a time period in which the output current remains at 0, which is different from the point in time when the output current becomes 0 at the moment when the direction changes from positive to negative or negative to positive in the alternating current waveform.

In operation 621, the controller 510 may control the power conversion apparatus 500 such that the output current exhibits a discontinuous waveform based on the operation mode being determined as a low-power mode. In this regard, a discontinuous waveform refers to a waveform that includes an operation interval and a pause interval.

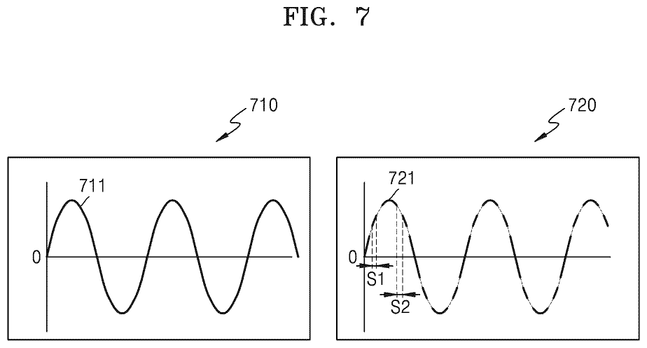

Meanwhile, specific examples of continuous and discontinuous waveforms that the output current may exhibit are described later with reference to FIG. 7, etc.

In an embodiment, the length of the operation interval and the length of the pause interval may each be set to be shorter than the alternating current voltage period of the power grid to which the power conversion apparatus 500 is connected. In an embodiment, the discontinuous waveform may constitute a portion of a sine curve, and the period of the sine curve may be equal to the period of the alternating current voltage of the power grid.

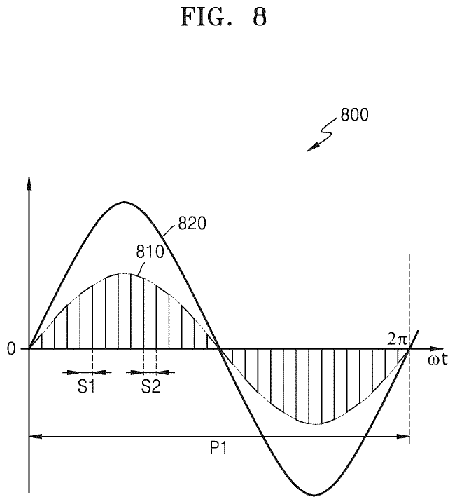

Meanwhile, examples of discontinuous waveforms in which the length of the operation interval and the length of the pause interval are set shorter than the alternating current voltage period of the power grid will be described later with reference to FIG. 8, etc.

In an embodiment, the controller 510 may control the power conversion apparatus 500 to output an output current by performing pulse width modulation (PWM) switching during the operation interval, and may control the power conversion apparatus 500 not to output an output current by not performing PWM switching during the pause interval. In an embodiment, each of the length of the operation interval and the length of the pause interval may be set longer than the pulse repetition period of the PWM switching.

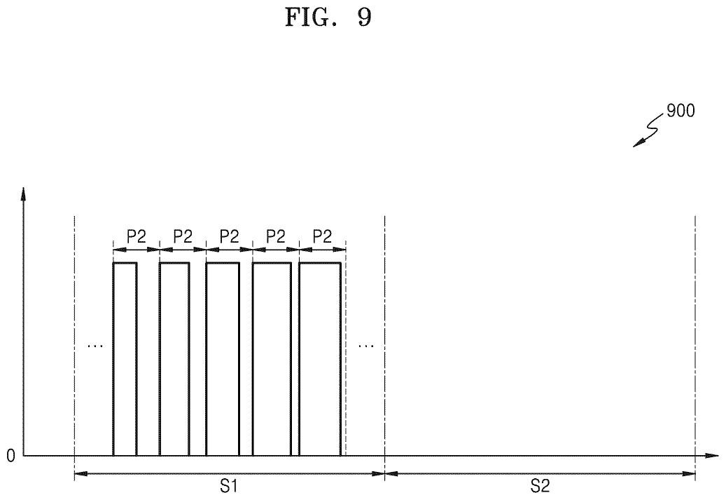

Meanwhile, the operation of the controller 510 in the operation interval and the pause interval which are related to PWM switching will be described later with reference to FIG. 9, etc.

In an embodiment, at least one of the operation interval and the pause interval may be configured such that the length of the interval varies over time. For example, at least one of the operation interval and the pause interval may be set such that the length of the interval repeatedly increases and decreases.

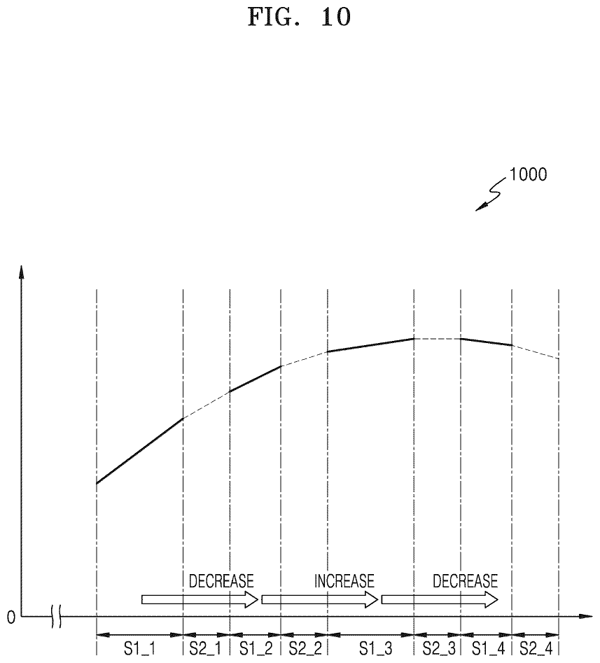

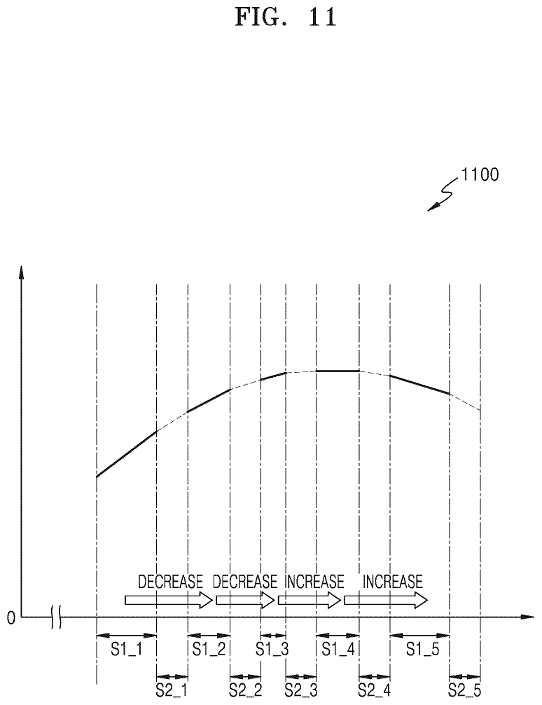

Meanwhile, the operation interval and/or the pause interval, in which the length of the interval is set to change over time, will be described later with reference to FIGS. 10 to 11, etc.

In an embodiment, the process including operations 610 to 620 or operations 610 to 621 may be performed repeatedly according to preset conditions. For example, the controller 510 may determine the operation mode of the power conversion apparatus 500 by identifying or determining the output power level of the power conversion apparatus 500 at preset intervals, and control the power conversion apparatus 500 according to the determined operation mode. In some embodiments, the controller 510 may be configured to change the output power level or detect that the output power level has changed, determine the operation mode of the power conversion apparatus 500 whenever the output power level changes, and control the power conversion apparatus 500 according to the determined operation mode.

FIG. 7 shows a view to explain continuous waveforms and discontinuous waveforms.

Referring to FIG. 7, a graph 710 is an example showing the current value of a continuous waveform 711 over time, and a graph 720 is an example showing the current value of a discontinuous waveform 721 over time.

As described above with reference to FIG. 6, the controller 510 may control the power conversion apparatus 500 such that the output current exhibits a continuous waveform 711 based on the operation mode being determined as the normal mode, and may control the power conversion apparatus 500 such that the output current exhibits a discontinuous waveform 721 based on the operation mode being determined as the low-power mode.

The discontinuous waveform 721 may include an operation interval S1 in which the power conversion apparatus 500 outputs current and a pause interval S2 in which the power conversion apparatus 500 does not output current, i.e., the output current of the power conversion apparatus 500 remains substantially at 0.

In an embodiment, the continuous waveform 711 represents a sine curve. For example, in case that the power conversion apparatus 500 is implemented as a grid-connected power conversion apparatus connected to a power grid, the power conversion apparatus 500 operating in a normal mode may output an output current representing the continuous waveform 711 having the same period as the alternating current voltage period of the power grid.

Meanwhile, the discontinuous waveform 721 may constitute a portion of a sine curve. That is, each operation interval S1 may constitute a portion of a sine curve. The discontinuous waveform 721 repeatedly includes the operation interval S1 that constitutes part of a sine curve and the pause interval S2 in which no output current appears, and when the discontinuous waveform 721 is approximated by the output current in the operation interval S1, the discontinuous waveform 721 may be approximated by a sine curve.

FIG. 8 shows a view to explain an operation interval and a pause interval.

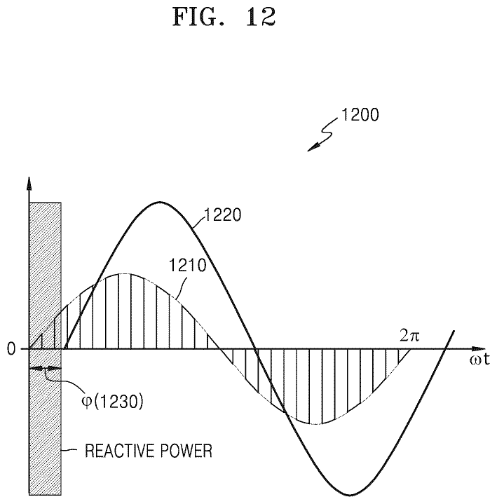

Referring to FIG. 8, a graph 800 illustrates a discontinuous waveform 810 of an output current in a low-power mode and a voltage waveform 820 of an alternating current voltage of a power grid to which the power conversion apparatus 500 is connected. Meanwhile, the graph 800 shows the discontinuous waveform 810 in a situation where no reactive power control is performed, and a detailed description of the discontinuous waveform 810 in a situation where reactive power control is performed will be described later with reference to FIG. 12.

In an embodiment, the length of the operation interval S1 and the length of the pause interval S2 may each be set shorter than an alternating current voltage period P1 of the power grid to which the power conversion apparatus 500 is connected. For example, the length of the operation interval S1 and the length of the pause interval S2 may each be set to be shorter than a certain time period set based on the alternating current voltage period P1. In some embodiments, the certain time period may represent a time period that is 1/n of the alternating current voltage period P1, such as ½ or ⅓ of the alternating current voltage period P1.

In some embodiments, the alternating current voltage period may be, but is not limited to, 16.7 ms (60 Hz) or 20 ms (50 Hz).

In an embodiment, the discontinuous waveform 810 may include a plurality of operation intervals S1 and a plurality of pause intervals S2 for a time period that is half of the alternating current voltage period P1. That is, the discontinuous waveform 810 may include n_1 operation intervals S1 and n_2 pause intervals S2 during a time period that is half of the alternating current voltage period P1. In this regard, n_1 and n_2 represent natural numbers greater than or equal to 2.

As described above with reference to FIG. 7, the discontinuous waveform 810 may constitute a portion of a sine curve, and when the discontinuous waveform 810 is approximated by an output current in the operation interval S1, the discontinuous waveform 810 may be approximated by a sine curve. In this regard, the sine curve constituted by the discontinuous waveform 810 may have the same period as the alternating current voltage period of the voltage waveform 820 of the alternating current voltage of the power grid.

Meanwhile, in case that the length of the pause interval S2 is set close to the alternating current voltage period P1 or exceeds the alternating current voltage period P1, the discontinuous waveform 810 may not be approximated to a sine curve. That is, in case that the time interval during which the output current is substantially 0 is set close to the alternating current voltage period P1 or exceeds the alternating current voltage period P1, the discontinuous waveform 810 may not be approximated to a sine curve having the same period as the alternating current voltage period of the voltage waveform 820 of the alternating current voltage of the power grid.

In an embodiment, by setting the length of the operation interval S1 and the length of the pause interval S2 to be shorter than a certain time period (e.g., the alternating current voltage period P1 of the power grid to which the power conversion apparatus 500 is connected), the discontinuous waveform 810 may be approximated to a sine curve having the same period as the alternating current voltage period.

FIG. 9 shows a view to explain a process of controlling a power conversion apparatus based on PWM switching.

In an embodiment, the power conversion apparatus 500 may output current based on PWM switching. For example, the power conversion apparatus 500 may synthesize an alternating current to be output according to a switching frequency by controlling ON/OFF of at least one power semiconductor switch (e.g., IGBT or MOSFET, etc.) with a switching signal. In this regard, the switching signal may include a gate signal configured to control a gate of a power semiconductor switch.

Referring to FIG. 9, the graph 900 illustrates an example of a switching signal appearing in an operation interval S1 and a pause interval S2 of a discontinuous waveform.

In an embodiment, the controller 510 may control the power conversion apparatus 500 to output an output current by performing PWM switching during the operation interval S1, and may control the power conversion apparatus 500 not to output an output current by not performing PWM switching during the pause interval S2.

That is, the controller 510 may repeatedly generate pulse waves for PWM switching during the operation interval S1. In an embodiment, the controller 510 may generate a pulse wave with a duty cycle corresponding to each preset pulse repetition period P2. Accordingly, in the operation interval S1, the switching signal is repeatedly generated, such that an output current is generated according to the switching signal.

Meanwhile, during the pause interval S2, the controller 510 may not drive the power semiconductor switch, may not perform PWM switching, such as blocking the output switching signal or setting the duty cycle to 0%. In this regard, the power conversion apparatus 500 may not output output current. By stopping PWM switching during the pause interval S2, switching loss and heat generation due to switching may be reduced.

The controller 510 may be configured to control the power conversion apparatus 500 such that the output current in the low-power mode exhibits a discontinuous waveform including the pause interval S2, thereby significantly improving the energy efficiency level even in a relatively low output situation.

Meanwhile, the pulse repetition period P2 of PWM switching may be set in the range of several kHz to several tens of kHz, but is not limited thereto. For example, the pulse repetition period P2 may be set to 0.1 ms (10 kHz), etc.

In an embodiment, the length of the operation interval S1 and the length of the pause interval S2 may each be set longer than the pulse repetition period P2 of the PWM switching. For example, the length of the operation interval S1 and the length of the pause interval S2 may each be set longer than a certain time period set based on the pulse repetition period P2. In some embodiments, the certain time period may represent a time period that is a multiple of the pulse repetition period P2, such as several times or tens of times the pulse repetition period P2.

Referring to FIG. 8 together, in an embodiment, the length of the operation interval S1 and the length of the pause interval S2 may each be set longer than the pulse repetition period P2 of PWM switching and shorter than the alternating current voltage period P1 of the power grid to which the power conversion apparatus 500 is connected.

Through this, the discontinuous waveform exhibited by the output current in the low-power mode may have a similar shape to the continuous waveform exhibited by the output current in the normal mode. In addition, since the discontinuous waveform has a form that is approximated as a sine curve in all cycles rather than a sine curve form in which some cycles are omitted, detailed applications of the power conversion apparatus 500, such as reactive power control, may be facilitated.

In addition, by introducing the pause interval S2, switching loss and heat generation due to PWM switching in low-power mode may be reduced, while maintaining high power quality by appropriately setting the lengths of the operation interval S1 and the pause interval S2.

Meanwhile, the lengths of the operation interval S1 and the pause interval S2 may be set differently depending on the maximum output of the power conversion apparatus 500, the rated output, environmental factors of the power supply system, and target efficiency, etc., and a person skilled in the art may set an appropriate time period depending on the usage environment.

FIGS. 10 and 11 show views to explain an operation interval or a pause interval, of which lengths change over time.

In a discontinuous waveform including the operation interval S1 and the pause interval S2, power quality may increase as the randomness of the length of the operation interval S1 and the length of the pause interval S2 increases. In an embodiment, at least one of the operation interval S1 and the pause interval S2 may be configured such that the length of the interval varies over time.

For example, at least one of the operation interval S1 and the pause interval S2 may be set such that the length of the interval is randomly determined within a preset range. In this regard, the maximum value of the preset range may be set based on the alternating current voltage period P1, and the minimum value may be set based on the pulse repetition period P2. In some embodiments, the length of every operation interval S1 may have a random value within a preset first range, and the length of every pause interval S2 may have a random value within a preset second range.

In some embodiments, at least one of the operation interval S1 and the pause interval S2 may be set such that the length of the interval repeatedly increases and decreases. In some embodiments, at least one of the operation interval S1 and the pause interval S2 may be set such that the length of the interval is constantly repeated to increase and decrease.

Referring to FIG. 10, a graph 1000 shows an example of a discontinuous waveform in which the pause interval S2 has a single interval length and the length of the operation interval S1 may increase and decrease consistently each time. Meanwhile, the length of the pause interval S2 may repeatedly increase and decrease independently of the operation interval S1, or the length of the operation interval S1 may be fixed and the length of the pause interval S2 may increase and decrease repeatedly.

In the graph 1000 illustrated in FIG. 10, all pause intervals S2, such as a first pause interval S2_1, a second pause interval S2_2, a third pause interval S2_3, and a fourth pause interval S2_4, have a single interval length, and the operation intervals S1, such as a first operation interval S1_1, a second operation interval S1_2, a third operation interval S1_3, and a fourth operation interval S1_4, may repeatedly increase and decrease.

In some embodiments, the length of the operation interval S1 may decrease from the first operation interval S1_1 to the second operation interval S1_2, increase from the second operation interval S1_2 to the third operation interval S1_3, and decrease again from the third operation interval S1_3 to the fourth operation interval S1_4. As a result, high power quality can be provided even if the output current exhibits a discontinuous waveform by increasing the randomness of the length of the operation interval S1 and the length of the pause interval S2 without using a complex random algorithm such as random number generation.

Referring to FIG. 11, a graph 1100 shows an example of a discontinuous waveform in which the pause interval S2 has a single interval length and the length of the operation interval S1 may repeatedly and gradually increase and decrease. Meanwhile, the length of the pause interval S2 may repeatedly increase and decrease independently of the operation interval S1, or the length of the operation interval S1 may be fixed and the length of the pause interval S2 may repeatedly and gradually increase and decrease.

In the graph 1100 illustrated in FIG. 11, all pause intervals S2, such as a first pause interval S2_1, a second pause interval S2_2, a third pause interval S2_3, a fourth pause interval S2_4, and a fifth pause interval S2_5, may have a single interval length, and operation intervals S1, such as a first operation interval S1_1, a second operation interval S1_2, a third operation interval S1_3, a fourth operation interval S1_4, and a fifth operation interval S1_5, may repeatedly and gradually increase and decrease.

In some embodiments, the length of the operation interval S1 may be decreased from the first operation interval S1_1 to the second operation interval S1_2, and from the second operation interval S1_2 to the third operation interval S1_3, thereby gradually decreasing from the first operation interval S1_1 to the third operation interval S1_3. In some embodiments, the length of the operation interval S1 may be gradually increased from the third operation interval S1_3 to the fourth operation interval S1_4, and from the fourth operation interval S1_4 to the fifth operation interval S1_5, thereby gradually increasing from the third operation interval S1_3 to the fifth operation interval S1_5.

As a result, high power quality can be provided even if the output current exhibits a discontinuous waveform by increasing the randomness of the length of the operation interval S1 and the length of the pause interval S2 without using a complex random algorithm.

FIG. 12 shows a view to explain a reactive power control process.

Referring to FIG. 12, a graph 1200 illustrates an example of a waveform 1220 representing an alternating current voltage of a power grid under reactive power control and a discontinuous waveform 1210 representing an output current of the power conversion apparatus 500.

Meanwhile, a phase shift 1230 refers to the phase shift that occurs between voltage and current, and represents the phase shift between the alternating current voltage of the power grid and the output current of the power conversion apparatus 500.

In the present disclosure, reactive power control refers to controlling the active and reactive components of alternating current power by intentionally adjusting the phase shift 1230. In an embodiment, the controller 510 may be configured to control the phase of the output current of the power conversion apparatus 500 such that the alternating current voltage of the power grid and the output current of the power conversion apparatus 500 are in phase, thereby making the power factor close to 1. In an embodiment, the controller 510 may be configured to control the phase of the output current of the power conversion apparatus 500 to generate reactive power by causing the output current of the power conversion apparatus 500 to lead or lag the alternating current voltage of the power grid.

As described above with reference to FIG. 9, the controller 510 may measure or receive information such as voltage and current input to the power conversion apparatus 500, and the alternating current voltage of the power grid in real time, and generate a switching signal for PWM control based on the information, thereby generating an output current.

In an embodiment, the controller 510 may perform reactive power control by adjusting the generation timing of the switching signal such that the phase shift 1230 for reactive power control occurs. As a result, the controller 510 may actively distribute the active and reactive components of the alternating current power generated by the power conversion apparatus 500.

In an embodiment, when the length of the operation interval S1 and the length of the pause interval S2 are appropriately set such that the discontinuous waveform 1210 has a shape that is approximated as a sine curve in all periods, rather than a sine curve shape in which some periods are omitted, the discontinuous waveform 1210 does not include an interval in which the output current is omitted for one or more periods. Accordingly, the discontinuous waveform 1210 may have a waveform synchronized to each period of the alternating current voltage of the power grid.

As a result, it is possible to perform phase shifting of the alternating current to correspond to all periods of the alternating current voltage, thereby enabling reactive power control through adjustment of the phase shift 1230. That is, since some entire periods are not omitted, voltage and current may be synchronized to continuously generate waveforms having the phase shift 1230, which may improve power quality when controlling reactive power.

According to the problem solving means of the present disclosure described above, the power conversion apparatus may be controlled in a manner that reduces switching loss and heat generation and provides high conversion efficiency in a situation where the output of the power conversion apparatus is low, and allows reactive power control.

In addition, the problem-solving means of the present disclosure may provide high conversion efficiency while minimizing additional circuit design and expand the detailed application range of the power conversion apparatus.

The effects of the embodiments are not limited to the effects described above, and other effects not described will be clearly understood by those skilled in the art from the description of this specification.

Meanwhile, embodiments according to the present disclosure may be implemented in the form of a computer program that can be executed through various components on a computer, and such a computer program may be recorded on a computer-readable medium. In this regard, the medium may include, but is not limited to, magnetic media such as hard disks, floppy disks, and magnetic tapes, optical recording media such as CD-ROMs and DVDs, magneto-optical media such as floptical disks, and hardware devices specifically configured to store and execute program instructions, such as ROM, RAM, and flash memory.

Meanwhile, the computer program may be specially designed and configured for the present disclosure or may be known and available to those skilled in the art of computer software. Examples of computer programs include not only machine language code, such as that produced by a compiler, but also high-level language code that may be executed by a computer using an interpreter or the like.

According to an embodiment, the method according to various embodiments of the present disclosure may be provided as included in a computer program product. Computer program products may be traded between sellers and buyers as commodities. The computer program product may be distributed in the form of a machine-readable storage medium (e.g., compact disc read only memory (CD-ROM)), or may be distributed online (e.g., by download or upload) via an application store (e.g., Play Store™) or directly between two user devices. In the case of online distribution, at least a portion of the computer program product may be temporarily stored or temporarily created in a device-readable storage medium, such as the memory of a manufacturer's server, an application store's server, or an intermediary server.

Unless there is a clear description or contradiction of the order of operations constituting the method according to the present disclosure, the operations may be performed in any suitable order. The present disclosure is not necessarily limited to the order in which the above steps are described. Any use of examples or exemplary terms (e.g., etc.) in this disclosure is merely intended to illustrate the disclosure in more detail and is not intended to limit the scope of the disclosure by virtue of such examples or exemplary terms, unless otherwise limited by the claims. Furthermore, those skilled in the art will appreciate that various modifications, combinations and variations may be made within the scope of the appended claims or their equivalents, depending on design conditions and factors.

Therefore, the spirit of the present disclosure should not be limited to the embodiments described above, and not only the patent claims described below, but also all scopes equivalent to or equivalently modified from such patent claims, should be considered to fall within the scope of the spirit of the present disclosure.

What is claimed is:

1. A method of controlling a power conversion apparatus, the method comprising:
determining an operation mode of the power conversion apparatus; and
based on the operation mode being determined as a low-power mode, controlling the power conversion apparatus such that an output current exhibits a discontinuous waveform including an operation interval and a pause interval,
wherein each of a length of the operation interval and a length of the pause interval is set to be shorter than an alternating current voltage period of a power grid to which the power conversion apparatus is connected.

2. The method of claim 1, wherein
the controlling comprises:
controlling the power conversion apparatus such that the output current is output by performing pulse width modulation (PWM) switching during the operation interval; and
controlling the power conversion apparatus such that the output current is not output by not performing the PWM switching during the pause interval.

3. The method of claim 2, wherein
each of the length of the operation interval and the length of the pause interval is set to be longer than a pulse repetition period of the PWM switching.

4. The method of claim 1, wherein
the discontinuous waveform constitutes a part of a sine curve, and
a period of the sine curve is identical to the alternating current voltage period of the power grid.

5. The method of claim 1, wherein
the power conversion apparatus comprises a grid-connected power conversion apparatus having an input to which a direct current power source is connected and an output to which the power grid is connected.

6. The method of claim 1, wherein
the determining comprises:
determining the operation mode based on an output power level of the power conversion apparatus.

7. The method of claim 6, wherein
the output power level is a power level corresponding to an operating point determined based on a maximum power point tracking (MPPT) algorithm.

8. The method of claim 1, wherein
at least one of the operation interval and the pause interval is set such that a length of the at least one of the operation interval and the pause interval varies over time.

9. The method of claim 8, wherein
at least one of the operation interval and the pause interval is set such that a length of the at least one of the operation interval and the pause interval repeatedly increases and decreases.

10. The method of claim 1, further comprising:
controlling the power conversion apparatus such that the output current exhibits a continuous waveform not including the pause interval, based on the operation mode being determined as a normal mode.

11. A power conversion apparatus comprising:
a controller configured to control an operation of the power conversion apparatus,
wherein the controller is further configured to:
determine an operation mode of the power conversion apparatus, and
based on the operation mode being determined as a low-power mode, control the power conversion apparatus such that an output current exhibits a discontinuous waveform including an operation interval and a pause interval, and
each of a length of the operation interval and a length of the pause interval is set to be shorter than an alternating current voltage period of a power grid to which the power conversion apparatus is connected.

12. The power conversion apparatus of claim 11, wherein
the controller is further configured to:
control the power conversion apparatus such that the output current is output by performing pulse width modulation (PWM) switching during the operation interval; and
control the power conversion apparatus such that the output current is not output by not performing the PWM switching during the pause interval.

13. The power conversion apparatus of claim 12, wherein
each of the length of the operation interval and the length of the pause interval is set to be longer than a pulse repetition period of the PWM switching.

14. The power conversion apparatus of claim 11, wherein
the discontinuous waveform constitutes a part of a sine curve, and
a period of the sine curve is identical to the alternating current voltage period of the power grid.

15. The power conversion apparatus of claim 11, wherein
the power conversion apparatus comprises a grid-connected power conversion apparatus having an input to which a direct current power source is connected and an output to which the power grid is connected.

16. The power conversion apparatus of claim 11, wherein
the controller is further configured to determine the operation mode based on an output power level of the power conversion apparatus.

17. The power conversion apparatus of claim 16, wherein
the output power level is a power level corresponding to an operating point determined based on a maximum power point tracking (MPPT) algorithm.

18. The power conversion apparatus of claim 11, wherein
at least one of the operation interval and the pause interval is set such that a length of the at least one of the operation interval and the pause interval varies over time.

19. The power conversion apparatus of claim 18, wherein
at least one of the operation interval and the pause interval is set such that a length of the at least one of the operation interval and the pause interval repeatedly increases and decreases.

20. The power conversion apparatus of claim 11, wherein
the controller is further configured to:
control the power conversion apparatus such that the output current exhibits a continuous waveform not including the pause interval, based on the operation mode being determined as a normal mode.
